(19) United States
(12) Patent Application Publication
(10) Pub. No.: US 2026/0227287 A1
(43) Pub. Date: Aug. 6, 2026

(54) DETECTING MISFIRE USING AN ARIMA MODEL

(71) Applicant: Robert Bosch GmbH, Stuttgart (DE)

(72) Inventors: Tushar Parulekar, Portage, MI (US); Sandeep Chilukuri, Farmington Hills, MI (US)

(21) Appl. No.: 19/044,062

(22) Filed: Feb. 3, 2025

(51) Int. Cl. G01M 15/11

(52) U.S. Cl. CPC G01M 15/11

(57) ABSTRACT

A system for detecting misfire using an autoregressive integrated moving average (ARIMA) model. The system includes an electronic processor. The electronic processor is configured to receive a signal from a speed sensor. The signal represents a speed of an engine. The electronic processor is also configured to, using the ARIMA model, determine constituents of the signal. The constituents include a residual constituent. The electronic processor is further configured to determine, based on a lowest value of the residual constituent, whether a misfire occurred and, when the misfire occurred, determine a time when the misfire occurred and determine, based on the time when the misfire occurred, a cylinder the misfire occurred in.

### SUMMARY

Internal combustion engines often include one or more cylinders and each cylinder is associated with a piston and a spark plug. In a spark ignited engine, combustion of ingested air-fuel mixture starts after a spark from the spark plug creates a flame front which propagates through the length of a cylinder away from the cylinder head (where the spark plug is generally mounted). In combustion engines, misfire may occur when the air-fuel mixture included in a cylinder of the combustion engine fails to ignite. There are a number of possible causes of misfire. For example, misfire may be caused by a faulty spark plug, a faulty ignition coil, a malfunctioning catalytic converter, a faulty sensor, failed or delayed combustion, a combination of the foregoing, or the like. Misfire may lead to an undesired reduction in engine speed and, consequently, in some implementations, vehicle speed.

Misfire may be detected based on the speed of the engine. However, it is difficult to determine which cylinder misfire occurred in by examining the raw signal received from a speed sensor that measures the speed of an engine. Therefore, the implementations described herein provide a system and method for accurately determining when misfire occurred and which cylinder of a multi-cylinder engine the misfire occurred in.

For example, one implementation provides, a system for detecting misfire using an autoregressive integrated moving average (ARIMA) model. The system includes an electronic processor. The electronic processor is configured to receive a signal from a speed sensor. The signal represents a speed of an engine. The electronic processor is also configured to, using the ARIMA model, determine constituents of the signal. The constituents include a residual constituent. The electronic processor is further configured to determine, based on a lowest value of the residual constituent, whether a misfire occurred and, when the misfire occurred, determine a time when the misfire occurred and determine, based on the time when the misfire occurred, a cylinder the misfire occurred in.

Another example implementation provides a method for detecting misfire using an ARIMA model. The method includes receiving a signal from a speed sensor. The signal represents a speed of an engine. The method also includes, using the ARIMA model, determining constituents of the signal. The constituents include a residual constituent. The method further includes determining, based on a lowest value of the residual constituent, whether a misfire occurred and, when the misfire occurred, determining a time when the misfire occurred and determining, based on the time when the misfire occurred, a cylinder the misfire occurred in.

### BRIEF DESCRIPTION OF THE DRAWINGS

FIG. 1 is a block diagram of an example system for detecting misfire using an autoregressive integrated moving average (ARIMA) model, in accordance with some implementations.

FIG. 2 is an example block diagram of the components included in the ECU of FIG. 1, in accordance with some implementations.

FIG. 3 is an example method for detecting misfire using an ARIMA model, in accordance with some implementations.

FIG. 4 is an example of a received signal indicative of misfire, in accordance with some implementations.

FIG. 5 is an example of a received signal indicative of misfire and constituents of the signal, in accordance with some implementations.

FIG. 6 is an example of a received signal indicative of misfire and constituents of the signal, in accordance with some implementations.

FIG. 7 is an example of a received signal indicative of misfire and constituents of the signal, in accordance with some implementations.

FIG. 8 provides an example flowchart of a method for detecting misfire using an ARIMA model, in accordance with some implementations.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

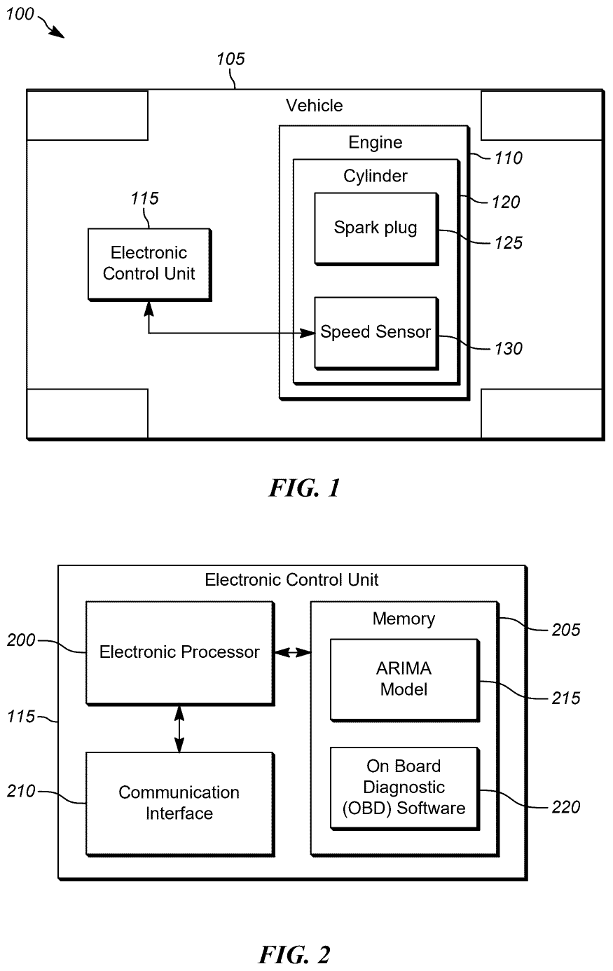

FIG. 1 illustrates an example system 100 for detecting misfire using an Autoregressive Integrated Moving Average (ARIMA) model. In the implementation illustrated in FIG. 1, the system 100 is included in a vehicle 105. While illustrated in FIG. 1 as a four-wheel vehicle, the vehicle 105 may be a different type of vehicle, for example, a two-wheel vehicle such as a motorcycle, a three-wheel vehicle such as a trike, or an eight-wheel vehicle such as a semi-truck. In the illustrated implementation, the system 100 includes an engine 110 and an electronic control unit (ECU) 115. The engine 110 includes a cylinder 120. A spark plug 125 attached to the cylinder 120 is configured to ignite the air-fuel mixture in the cylinder 120. A speed sensor 130 may be mounted on or near the engine (for example, on or near a crankshaft) and configured to measure the speed of the engine 110. In some implementations, the engine 110 includes a plurality of cylinders rather than the single cylinder 120 illustrated in FIG. 1 and each of the plurality of cylinders includes a spark plug.

In some implementations, the ECU 115 is electrically and communicatively coupled to the speed sensor 130 via direct or indirect connections or by or through one or more control or data buses, which enable communication therebetween. In some instances, the bus is a Controller Area Network (CAN™) bus. In some instances, the bus is an automotive Ethernet™, a FlexRay™ communications bus, or another suitable bus. In alternative instances, some or all of the components of the vehicle 105 may be communicatively coupled using suitable wireless modalities (for example, Bluetooth™ or near field communication connections). Connections illustrated in FIG. 1 as being unidirectional may be, in some implementations, bidirectional. Connections illustrated in FIG. 1 as being bidirectional may be, in some implementations, unidirectional.

FIG. 2 illustrates an example of the components included in the ECU 115. In the example shown, the ECU 115 includes an electronic processor 200 (for example, a microprocessor, application specific integrated circuit, etc.), a memory 205, and a communication interface 210. The memory 205 may be made up of one or more non-transitory computer-readable media. The memory 205 can include combinations of different types of memory, such as read-only memory (“ROM”), random access memory (“RAM”), electrically erasable programmable read-only memory (“EEPROM”), flash memory, or other suitable memory devices. The electronic processor 200 is coupled to the memory 205 and the communication interface 210. The electronic processor 200 sends and receives information (for example, from the memory 205 and/or the communication interface 210) and processes the information by executing one or more software instructions or modules, capable of being stored in the memory 205, or another non-transitory computer readable medium. The software can include firmware, one or more applications, program data, filters, rules, one or more program modules, and other executable instructions. In some examples, the electronic processor 200 is configured to retrieve from the memory 205 and execute, among other things, software for performing methods as described herein. For example, the memory 205 includes an ARIMA model 215 and OBD software 220.

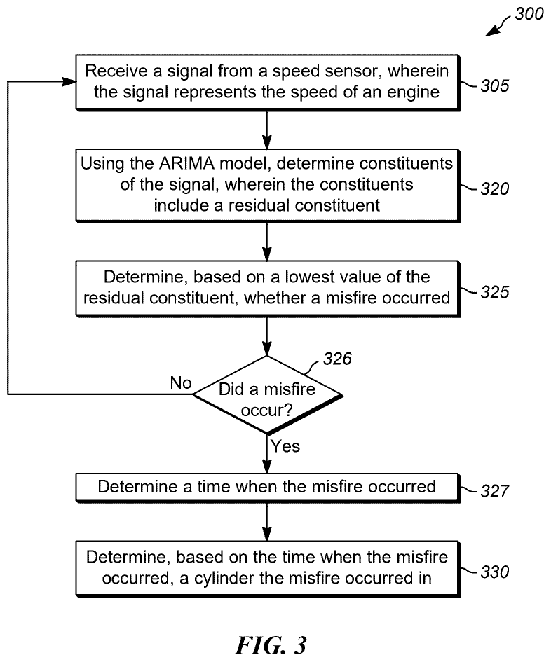

FIG. 3 is an example method 300 for detecting misfire using an ARIMA model, in accordance with some implementations. In some implementations, the method 300 begins at block 305 when the electronic processor 200 receives a signal from a speed sensor (for example, the speed sensor 130). In some implementations, the signal represents the speed of an engine (for example the engine 110) or speed data collected during a predetermined window of time (for example, a window of time in which one combustion cycle occurs). The electronic processor 200 may, at block 320, using the ARIMA model (for example, the ARIMA model 215), determine constituents of the signal. In some implementations, the constituents include a seasonality constituent, a trend constituent, and a residual constituent. In some implementations, the seasonality constituent represents the seasonality characteristic of the speed sensor signal or the base component of the speed sensor signal. The seasonality characteristic represents regular and predictable changes that occur on the speed sensor signal at regular interval (for example, every combustion). In some implementations, the trend constituent represents the trend characteristic of the speed sensor signal. The trend characteristic represents gradual changes in the speed sensor signal such as increases or decreases in values (amplitude) occurring over long time period (for example, hundreds of combustions). In some implementations, the residual constituent represents the residual characteristic of the speed sensor signal. The residual characteristic of the signal represents noise or sudden non-repeating changes in the speed sensor signal.

In some implementations, prior to performing the functionality described in relation to blocks 320-330, the electronic processor 200 determines, based on the raw speed signal, whether a misfire occurred in a cylinder (for example, the cylinder 120) included in the engine 110. In some implementations, the electronic processor 200 utilizes signal filtration techniques to determine whether misfire occurred. In some implementations, the electronic processor 200 determines that a misfire occurred when the electronic processor 200 determines an irregularity in engine speed. In some implementations, the electronic processor 200 may determine that an irregularity in engine speed exists when the speed of the engine 110 decreases momentarily. For example, when the engine speed is about 2300 rotations per minute (rpm) then suddenly the engine speed drops to 0 rpm and increases back up to 2300 rpm, the electronic processor 200 may determine that there was an irregularity in engine speed and, therefore, a misfire. In other implementations, the electronic processor 200 determines that a misfire may have occurred when there is sudden rise in engine lambda (the engine lambda goes leaner). Engine lambda is a ration of air to fuel in a combustion chamber or cylinder.

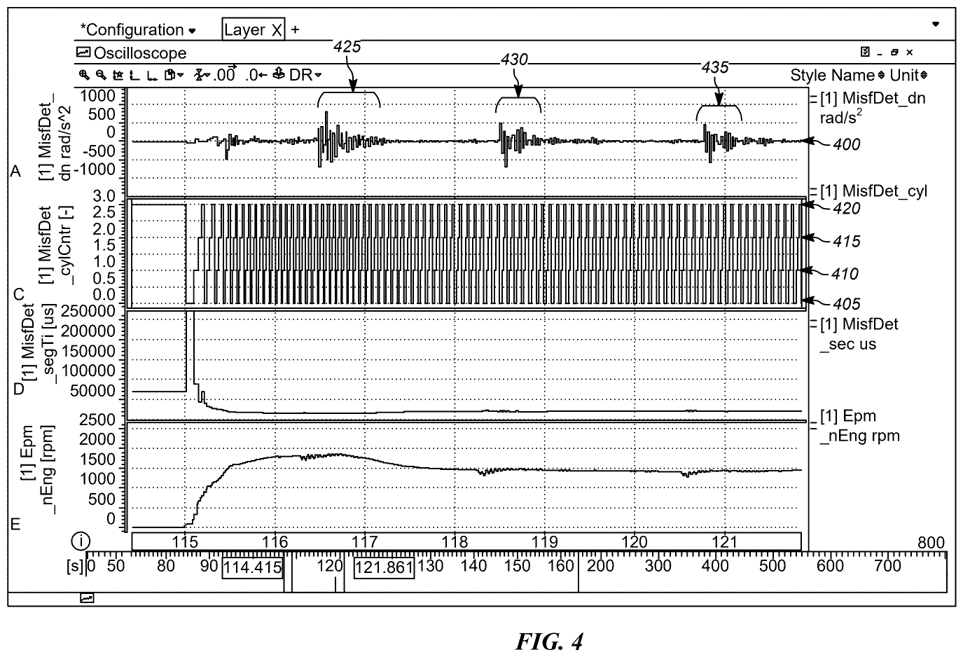

FIG. 4 is an example of a received signal 400 indicative of misfire, in accordance with some implementations. FIG. 4 also illustrates a cylinder counter maintained by the electronic processor 200 that indicates which cylinder of the engine 110 is expected to be firing (includes a spark plug that is expected to be igniting the air-fuel mixture). In the example illustrated in FIG. 4, line 405 represents a firing of a first cylinder included in the engine 110, line 410 represents a firing of a second cylinder included in the engine 110, line 415 represents a firing of a third cylinder included in the engine 110, and line 420 represents a firing of a fourth cylinder included in the engine 110. In the example illustrated in FIG. 4, misfire occurs during time window 425, time window 430, and time window 435. While it may be determined that misfire occurred during a window of time based on the speed signal due to, for example, noise in the speed signal, it is difficult to determine the precise moment in the window of time when the misfire occurred. Because the precise moment in a window of time when the misfire occurred cannot be accurately determined by examining the speed signal alone, the cylinder that the misfire occurred in cannot be determined by examining the speed signal alone. As illustrated in FIG. 4 multiple cylinders fire in the windows of time when misfires occur. However, by examining the constituents of the speed signal, the electronic processor 200 may determine the moment when the misfire occurred with enough accuracy to determine which cylinder the misfire occurred in. The seasonality, trend, and residual constituents repeat themselves and therefore provide reference noise on the engine 110. Only when there is variation in the residual (sharp noise), did a misfire occur. The trend and seasonality constituents separate out the repeatability in the speed sensor signal, allowing variation in the residual constituent to be pronounced and, therefore, aiding in the determination of whether misfire occurred and when misfire occurred.

In some implementations, the electronic processor 200 determines a portion of the signal associated with the window of time in which the misfire occurred and, at block 320, determines constituents of the portion of the signal. In some implementations, the electronic processor 200 proceeds to perform the functionality described in relation to block 320-330 when the electronic processor 200 determines, based on the signal from the speed sensor 130, that misfire occurred. When the electronic processor 200 does not determine that misfire occurred based on the signal from the speed sensor 130, the electronic processor 200 may return to performing the functionality described in relation to block 305.

In some implementations, at block 325, the electronic processor 200 determines, based on a lowest value of the residual constituent, whether a misfire occurred. In one instance, the electronic processor 200 determines that a misfire has occurred when the lowest value of the residual is less than or equal to a predetermined threshold. In another instance, the electronic processor 200 determines that a misfire has occurred when the lowest value of the residual is less than a predetermined threshold. In implementations where the electronic processor 200 examines the raw signal from the speed sensor 130 to determine whether misfire occurred, the electronic processor 200 may also examine the residual constituent to confirm that misfire occurred. When, at block 325, the electronic processor 200 does not determine or confirm that misfire occurred, the electronic processor 200 may return to performing the functionality described in relation to block 305. When, at block 326, the electronic processor 200 determines or confirms that misfire occurred, at block 327, the electronic processor 200 determines a time when the misfire occurred. The electronic processor 200 may determine that the misfire occurred at the point in time when the residual constituent reached its lowest value during the predetermined window of time that the speed data was collected or the window of time that the electronic processor 200 determined that the misfire occurred within. In some implementations, at block 330, the electronic processor 200 determines, based on the time when the misfire occurred, a cylinder the misfire occurred in. In some implementations, the electronic processor 200 determines the cylinder the misfire occurred in is a cylinder that, according to the cylinder counter, was expected to be firing at the time when the misfire occurred.

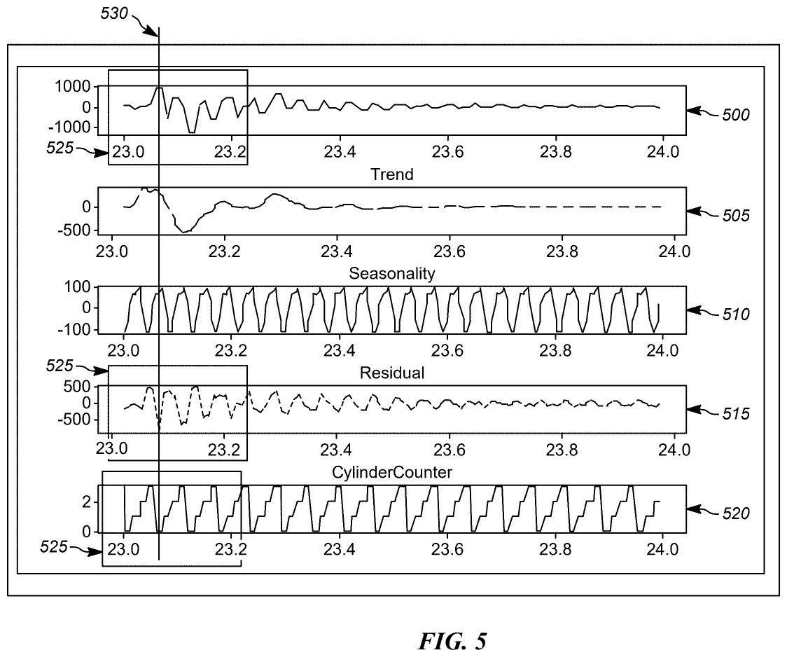

FIG. 5 is an example of a received signal indicative of misfire and constituents of the signal, in accordance with some implementations. In the example illustrated in FIG. 5, graph 500 represents a speed signal received from a speed sensor (for example, the speed sensor 130), graph 505 represents a trend constituent of the speed signal represented by the graph 500, graph 510 represents a seasonality constituent of the speed signal represented by the graph 500, graph 515 represents a residual constituent of the speed signal represented by the graph 500, and graph 520 represents a cylinder counter maintained by the electronic processor 200. The x-axis of each of the graphs 500-520 represents time and the y-axis represents amplitude. The blocks 525 represent a window of time in which a misfire occurred. The window of time is determined based on the speed signal. The lowest value of the residual during the window of time is illustrated by the line 530. The cylinder counter indicates that when the residual value was lowest was when the first cylinder fired.

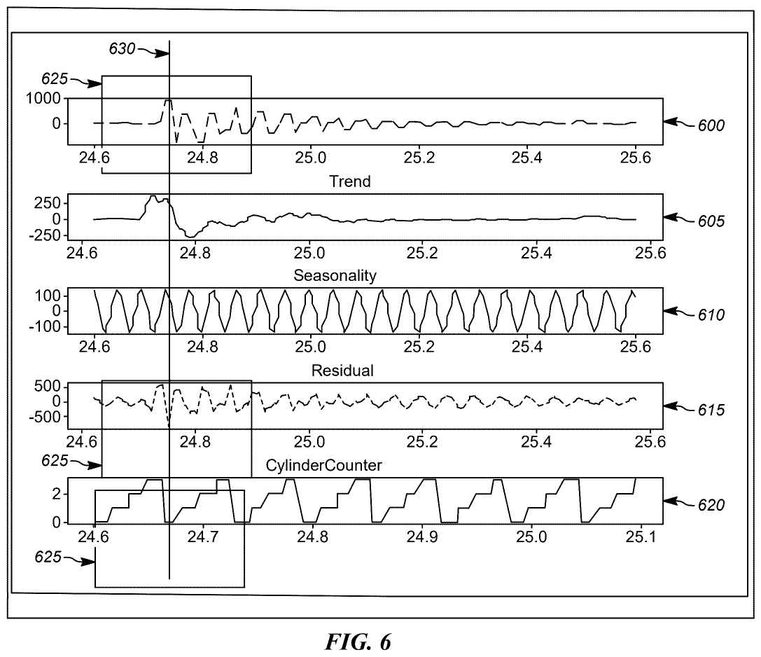

FIG. 6 is an example of a received signal indicative of misfire and constituents of the signal, in accordance with some implementations. In the example illustrated in FIG. 6, graph 600 represents a speed signal received from a speed sensor (for example, the speed sensor 130), graph 605 represents a trend constituent of the speed signal represented by the graph 600, graph 610 represents a seasonality constituent of the speed signal represented by the graph 600, graph 615 represents a residual constituent of the speed signal represented by the graph 600, and graph 620 represents a cylinder counter maintained by the electronic processor 200. The x-axis of each of the graphs 600-620 represents time and the y-axis represents amplitude. The blocks 625 represent a window of time in which a misfire occurred. The window of time is determined based on the speed signal. The lowest value of the residual during the window of time is illustrated by the line 630. The cylinder counter indicates that when the residual value was lowest was when the first cylinder fired.

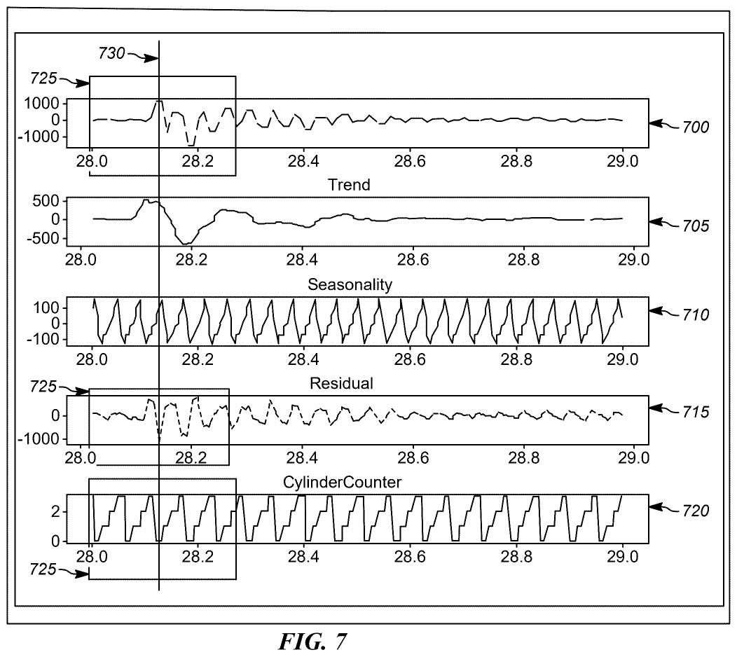

FIG. 7 is an example of a received signal indicative of misfire and constituents of the signal, in accordance with some implementations. In the example illustrated in FIG. 7, graph 700 represents a speed signal received from a speed sensor (for example, the speed sensor 130), graph 705 represents a trend constituent of the speed signal represented by the graph 700, graph 710 represents a seasonality constituent of the speed signal represented by the graph 700, graph 715 represents a residual constituent of the speed signal represented by the graph 700, and graph 720 represents a cylinder counter maintained by the electronic processor 200. The x-axis of each of the graphs 700-720 represents time and the y-axis represents amplitude. The blocks 725 represent a window of time in which a misfire occurred. The window of time is determined based on the speed signal. The lowest value of the residual during the window of time is illustrated by the line 730. The cylinder counter indicates that when the residual value was lowest was when the first cylinder fired.

In some implementations, the electronic processor 200, executing the OBD software 220, maintains a misfire count of the number of times a misfire has occurred in each cylinder included in the engine 110. In some implementations, when a cylinder that misfire occurred in is determined, the electronic processor 200 increases the misfire count associated with the cylinder. For example, when the engine 110 has four cylinders, the misfire count associated with the first cylinder is three, the misfire count associated with the second cylinder is one, the misfire count associated with the third cylinder is zero, the misfire count associated with the fourth cylinder is one, and the electronic processor 200, executing the method 300 determines that misfire occurred in the first cylinder, the electronic processor 200 increases the misfire count associated with the first cylinder to four.

In some implementations, the electronic processor 200 compares the misfire count associated with each cylinder included in the engine 110 to a predetermined threshold (for example, 5 or 10). In some implementations, when the misfire count associated with a cylinder is greater than or equal to the predetermined threshold, the electronic processor 200 generates an alert. In other implementations, when the misfire count associated with a cylinder is greater than the predetermined threshold, the electronic processor 200 generates an alert. For example, the alert generated by the electronic processor 200 may be the illumination of a light on a dashboard of the vehicle 105, the display of a message or icon on a heads-up display included in the vehicle 105, output of an aural message or warning via one or more speakers included in the vehicle 105, a combination of the foregoing, or the like.

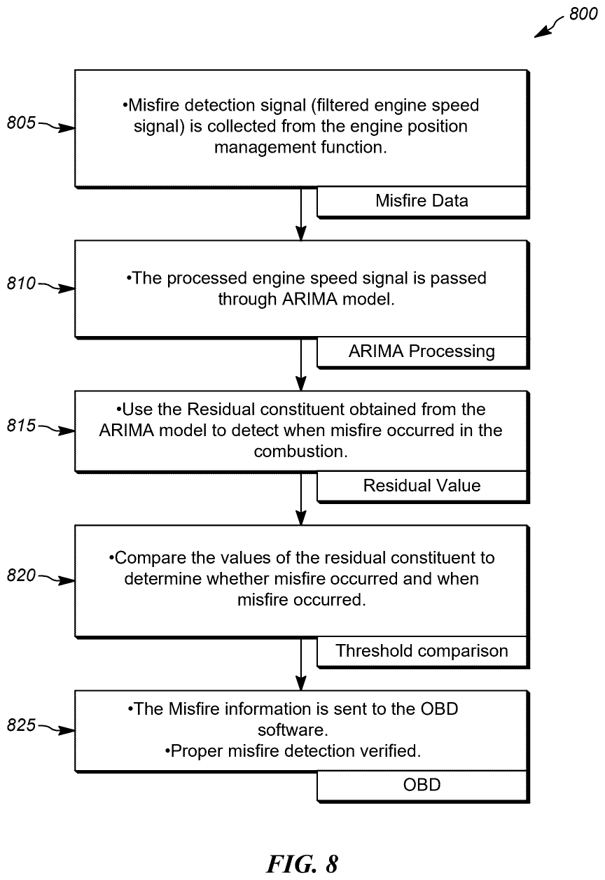

FIG. 8 is another example flowchart of a method 800 for detecting misfire using an ARIMA model. Similar to block 305, at block 805, the electronic processor 200 receives speed data or a signal from the speed sensor 130. In some implementations, the electronic processor 200 utilizes an engine position management function included in the memory 205 to process the raw signal received from the speed sensor 130. At block 810, like at block 320, an ARIMA model is used to determine the constituents of the signal. At block 815, the electronic processor 200, determines the lowest value of the residual and at, block 820, the electronic processor 200 determines whether a misfire occurred and when the misfire occurred. In some implementations, at block 825, the electronic processor 200 may execute the OBD software 220 to modify the misfire count associated with a cylinder when misfire occurred.

Thus, examples, aspects, and features herein provide, among other things, systems and methods for detecting misfire using an ARIMA model.

What is claimed is:

1. A system for detecting misfire using an autoregressive integrated moving average (ARIMA) model, the system comprising:
an electronic processor, the electronic processor configured to:
receive a signal from a speed sensor, wherein the signal represents a speed of an engine;
using the ARIMA model, determine constituents of the signal, wherein the constituents include a residual constituent;
determine, based on a lowest value of the residual constituent, whether a misfire occurred; and
when the misfire occurred,
determine a time when the misfire occurred; and
determine, based on the time when the misfire occurred, a cylinder the misfire occurred in.

2. The system according to claim 1, wherein the received signal represents speed data collected during a predetermined window of time.

3. The system according to claim 1, wherein the constituents include a seasonality constituent, a trend constituent, and the residual constituent.

4. The system according to claim 1, wherein the electronic processor is configured to:
when the cylinder the misfire occurred in is determined, increase a misfire count associated with the cylinder.

5. The system according to claim 4, wherein the electronic processor is configured to:
compare the misfire count to a predetermined threshold; and
when the misfire count is greater than or equal to the predetermined threshold, generate an alert.

6. The system according to claim 1, wherein the electronic processor is further configured to:
determine, based on the signal, whether the misfire occurred; and
when a misfire occurred, determine a portion of the signal in which the misfire occurred.

7. The system according to claim 6, wherein the electronic processor is configured to, using the ARIMA model, determine constituents of the signal by:
using the ARIMA model, determining the constituents of the portion of the signal.

8. The system according to claim 6, wherein the electronic processor is configured to determine, based on the signal, whether a misfire occurred by:
determining whether an irregularity in the speed of the engine exists, wherein the irregularity in the speed of the engine is an unexpected decrease in the speed of the engine.

9. The system according to claim 1, wherein the electronic processor is configured to determine, based on a lowest value of the residual constituent, whether a misfire occurred by:
determining a misfire occurred when the lowest value of the residual constituent is less than or equal to a predetermined threshold.

10. The system according to claim 1, wherein the electronic processor is configured to determine, based on the time when the misfire occurred, a cylinder the misfire occurred in by:
determining the cylinder the misfire occurred in is a cylinder that, according to a cylinder counter, was expected to be firing at the time when the misfire occurred.

11. A method for detecting misfire using an autoregressive integrated moving average (ARIMA) model, the method comprising:
receiving a signal from a speed sensor, wherein the signal represents a speed of an engine;
using the ARIMA model, determining constituents of the signal, wherein the constituents include a residual constituent;
determining, based on a lowest value of the residual constituent, whether a misfire occurred; and
when the misfire occurred,
determining a time when the misfire occurred; and
determining, based on the time when the misfire occurred, a cylinder the misfire occurred in.

12. The method according to claim 11, wherein the received signal represents speed data collected during a predetermined window of time.

13. The method according to claim 11, wherein the constituents include a seasonality constituent, a trend constituent, and the residual constituent.

14. The method according to claim 11, the method further comprising:
when the cylinder the misfire occurred in is determined, increasing a misfire count associated with the cylinder.

15. The method according to claim 14, the method further comprising:
comparing the misfire count to a predetermined threshold; and
when the misfire count is greater than or equal to the predetermined threshold, generating an alert.

16. The method according to claim 11, the method further comprising:
determining, based on the signal, whether the misfire occurred; and
when a misfire occurred, determining a portion of the signal in which the misfire occurred.

17. The method according to claim 16, wherein, using the ARIMA model, determining constituents of the signal includes:
using the ARIMA model, determining the constituents of the portion of the signal.

18. The method according to claim 16, determining, based on the signal, whether a misfire occurred includes:
determining whether an irregularity in the speed of the engine exists, wherein the irregularity in the speed of the engine is an unexpected decrease in the speed of the engine.

19. The method according to claim 11, wherein determining, based on a lowest value of the residual constituent, whether a misfire occurred includes:
determining a misfire occurred when the lowest value of the residual constituent is less than or equal to a predetermined threshold.

20. The method according to claim 11, wherein determining, based on the time when the misfire occurred, a cylinder the misfire occurred in includes:
determining the cylinder the misfire occurred in is a cylinder that, according to a cylinder counter, was expected to be firing at the time when the misfire occurred.
